(19) United States
(12) Patent Application Publication
(10) Pub. No.: US 2003/0125054 A1
(43) Pub. Date: Jul. 3, 2003

(54) Portable messaging device adapted to perform financial transactions

(76) Inventor: Sergio Salvador Garcia, Shanghai (CN)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/304,830

(22) Filed: Nov. 26, 2002

Related U.S. Application Data
(60) Provisional application No. 60/333,389, filed on Nov. 26, 2001.

(51) Int. Cl. H04Q 7/20; H04M 1/68; H04B 1/38

(52) U.S. Cl. 455/466; 455/411; 455/558

(57) ABSTRACT

A portable messaging device for sending and receiving messages over a mobile communications system. In one embodiment, the device includes a touch pad for receiving handwritten symbols as input from a first user, a conversion module programmed to convert the input to an outgoing message composed of a series of characters in a pre-defined character set, a transmitter to transmit the outgoing message to a mobile communications system, and a receiver for receiving messages from the mobile communications system. The device can be adapted for use in existing mobile communications systems and does not require a keypad to transmit text messages to remote users. The device may be further adapted to facilitate financial transactions initiated by the user. For example, the user may use the device as a credit card in the purchase of goods or services from a merchant.

### FIELD OF THE INVENTION

The present invention relates to portable communication devices, and is more particularly concerned with communication devices adapted to send/receive handwritten input from users. The device has the added security of using biometric signature software.

### BACKGROUND OF THE INVENTION

In a typical pager system, a caller dials a number, which is assigned to a specific pager. The call is answered by a paging terminal, which can transfer the call to the pager. The pager alerts the user carrying the pager by an alarm, a bell, or some other alert mechanism. In some paging systems, the caller may also communicate a message to the paging terminal (e.g. via a telephone keyboard or computer), which can be a phone number or a more lengthy text message, for example. The paging terminal queues the message with others that it needs to send, encodes it, and passes it along to a mobile communications system in the form of a paging signal. Transmitters send the paging signal out to one or more paging areas or zones, where the specific pager for which the message is intended receives the signal. A decoding mechanism in the specific pager is adapted to decode the paging signal to determine which messages are for it, and to decode those messages so that the user can process them for viewing or access.

Typical pagers do not provide users with the capability of transmitting messages to other paging devices carried by remote users. Similar devices that are equipped with means for transmitting messages often require input to be typed on a keyboard or a keypad (e.g. a telephone keypad) which can be troublesome. Some wireless devices are equipped with handwriting recognition programs to facilitate easier message generation; however, these wireless devices often require a connection to the Internet to transmit messages between devices. Furthermore, such wireless devices are typically more expensive compared to simple pager devices, as these wireless devices are primarily designed to perform a range of complex tasks in addition to basic messaging functions, including organizer functions (e.g. personal digital assistants) or to permit voice communication (e.g. cellular phones).

### SUMMARY OF THE INVENTION

The present invention relates to portable communication devices, and is more particularly concerned with communication devices adapted to send/receive handwritten input from users. The device has the added security of using biometric signature software.

In one aspect, the present invention relates to a messaging device comprising: a touch pad for receiving input from a first user, wherein the input comprises a plurality of handwritten symbols written on the touch pad; a controller operatively coupled to the touch pad; a conversion module programmed to associate each of the plurality of handwritten symbols to at least one of a plurality of pre-defined characters, wherein said controller is adapted to generate outgoing message data comprised of pre-defined characters associated with the plurality of handwritten symbols and wherein said outgoing message data also comprises contact data corresponding to an intended recipient of the message data; memory storage operatively coupled to the controller; a transmitter adapted to transmit the outgoing message to a mobile communications system wherein the transmitter is not adapted to transmit voice communications; and a receiver for receiving data from the mobile communications system.

In another aspect, the present invention relates to a messaging device comprising: means for receiving input from a first user, wherein the input comprises a plurality of handwritten symbols; means for converting the plurality of handwritten symbols to a plurality of pre-defined characters; means for generating an outgoing message comprised of the plurality of pre-defined characters and wherein said outgoing message comprises contact data corresponding to an intended recipient of the message data; means for transmitting the outgoing message to a mobile communications system; and means for receiving messages from the mobile communications system.

In another aspect, the present invention relates to a method of generating and transmitting a message to a remote user using a portable messaging device, wherein the portable messaging device is not adapted to transmit voice communications, the method comprising the steps of: receiving as input from a first user a plurality of handwritten symbols; associating each of the plurality of handwritten symbols to at least one of a plurality of predefined characters; generating an outgoing message comprised of predefined characters associated with the plurality of handwritten symbols and wherein said outgoing message comprises contact data associated with said remote user; transmitting the outgoing message to the mobile communications system.

In another aspect, the present invention relates to a method of generating and transmitting a message to a remote user using a portable messaging device, wherein the portable messaging device is not adapted to transmit voice communications, the method comprising the steps of receiving as input from a first user a selection identifying one of a plurality of user-defined first messages stored in a memory, transmitting the first message identified by the selection to a second user through a mobile communications system.

In accordance with the present invention, a messaging device is provided that can be adapted for use in mobile communications systems and does not require an Internet connection to transmit or receive messages between users. In accordance with preferred embodiments of the invention, the messaging device accepts handwritten input; a keyboard or keypad is not necessary to generate and transmit messages to remote users. The messaging device preferably does not function as a personal digital assistant or portable organizer, and does not require the voice communication capability of mobile or cellular phones. Accordingly, the messaging device can be manufactured at a relatively low cost.

In preferred embodiments of the present invention, messages can be both transmitted to and received from messaging devices operated by users over a mobile communications system. The present invention may also be adapted to transmit messages to and receive messages from other devices coupled to the mobile communications system, including pagers, cellular phones, personal digital assistants, systems connected to the Internet, or other messaging devices, for example.

In variant embodiments of the present invention, the messaging device may be further adapted to facilitate financial transactions initiated by the user. For example, the messaging device can function as a credit card in the purchase of goods or services by the user. Financial transactions are initiated by the user manually entering transaction details on the messaging device. Alternatively, transaction details may be input to the device through an infrared or a similar data entering chip or method of input. The messaging device subsequently requests initiation and approval of the transaction from a financial institution, and confirmation of the transaction is communicated to the user by the financial institution. Most preferably, by using biometrics software, a handwritten signature of the user entered into the messaging device is used to authenticate the identity of the user in the performance of the financial transaction.

The present invention is also directed towards a method of performing a financial transaction using a portable messaging device, said method comprising the steps of:

a) identifying a type of financial transaction to be initiated;

b) receiving transaction details;

c) obtaining biometric identification from said user and authenticating said user;

d) requesting approval of said financial transaction from a financial institution; and

e) obtaining confirmation of said financial transaction.

The present invention is further directed towards a card device having a housing configured to operatively engage a card reader and a magnetic stripe mounted to the housing, wherein said magnetic strip stores account data. The card device also includes a touch pad for receiving input from a user, wherein said input comprises a signature and a controller operatively coupled to the touch pad. The controller is adapted to generate outgoing message data which includes authorization data and account data. The card device also includes a transmitter adapted to transmit said outgoing message data to a mobile communications system.

The present invention is also directed towards a method of performing a financial transaction using a card reader. The method includes the steps of:

a) providing a portable card device adapted to operatively communicate with said card reader;

b) providing transaction details to the card reader;

c) transmitting transaction details data from said card reader to a financial institution associated with said account data;

d) requiring the user to sign the card device;

e) transmitting authorization data from the card device to said financial institution;

f) requesting approval of said financial transaction from said financial institution;

g) processing said financial transaction; and

h) obtaining confirmation of said financial transaction.

### BRIEF DESCRIPTION OF THE DRAWINGS

For a better understanding of the present invention, and to show more clearly how it may be carried into effect, reference will now be made, by way of example, to the accompanying drawings which show preferred embodiments and variant embodiments of the present invention, and in which:

FIG. 1A is a schematic diagram illustrating components of a preferred embodiment of a messaging device made in accordance with the present invention;

FIG. 1B is a schematic diagram illustrating components of a first variant embodiment of a messaging device made in accordance with the present invention;

FIG. 1C is a front view of a second variant embodiment of a messaging device made in accordance with the present invention;

FIG. 1D is a rear view of the messaging device of FIG. 1C;

FIG. 2A is a flowchart illustrating the steps of a method of generating and transmitting messages carried out by the messaging device of FIG. 1A;

FIG. 2B is a flowchart illustrating the steps of a method of selecting a recipient for an outgoing message carried out by the messaging device of FIG. 1A;

FIG. 2C is a flowchart illustrating the steps of a method of inputting or generating an outgoing message to be sent to a recipient or remote user carried out by the messaging device of FIG. 1A;

FIGS. 3A to 3N illustrate examples of output shown in the display of the messaging device of FIG. 1A in use;

FIG. 4A is a flowchart illustrating the steps of a method of generating and transmitting messages and financial transactions carried out by the messaging device of FIG. 1B;

FIG. 4B is a flowchart illustrating the steps performed by the messaging device of FIG. 1B in a financial transaction mode;

FIG. 4C is a schematic diagram illustrating the use of an external transaction hub in a transfer of funds by the messaging device of FIG. 1B; and

FIGS. 5A to 5E illustrate examples of output shown on a display of the messaging device of FIG. 1B in use.

### DETAILED DESCRIPTION OF THE INVENTION

The present invention relates generally to portable communication devices.

The present invention is directed to a messaging device adapted to receive handwritten input from users, and to a method of generating and transmitting messages using the messaging device. A keyboard or keypad (e.g. a telephone keypad) is not needed to generate messages for transmission to remote users, and therefore, the generation and transmission of such messages can be performed relatively conveniently and quickly.

Furthermore, the present invention is directed to a messaging device that can be adapted for use in mobile communications systems, including for example, systems that operate using the Global System for Mobile Communications (GSM) standard. Unlike many other personal digital assistants (PDAs) and mobile or cellular phones equipped to transmit text messages to other devices, the messaging device of the present invention does not require an Internet connection to transmit messages. Accordingly, the messaging device of the present invention can be designed for use in an existing mobile communications system used primarily by paging devices.

The messaging device need not include additional functionality found in most PDAs or portable organizers, and does not provide voice communication capability as found in mobile or cellular phones. In a preferred embodiment, the messaging device sends and receives messages sent using the Short Messaging Service (SMS) protocol. Accordingly, the messaging device can be manufactured at a relatively lower cost, and messages can be transmitted at a relatively lower cost. Use of these messaging devices may also be desirable in geographical regions where cellular phone service or equipment is extremely costly, or where cellular phone networks do not exist.

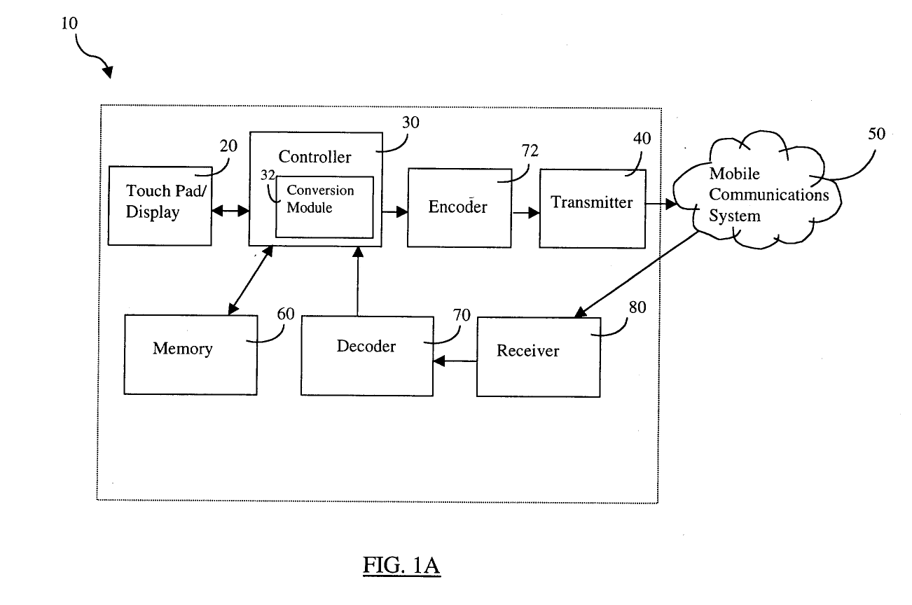

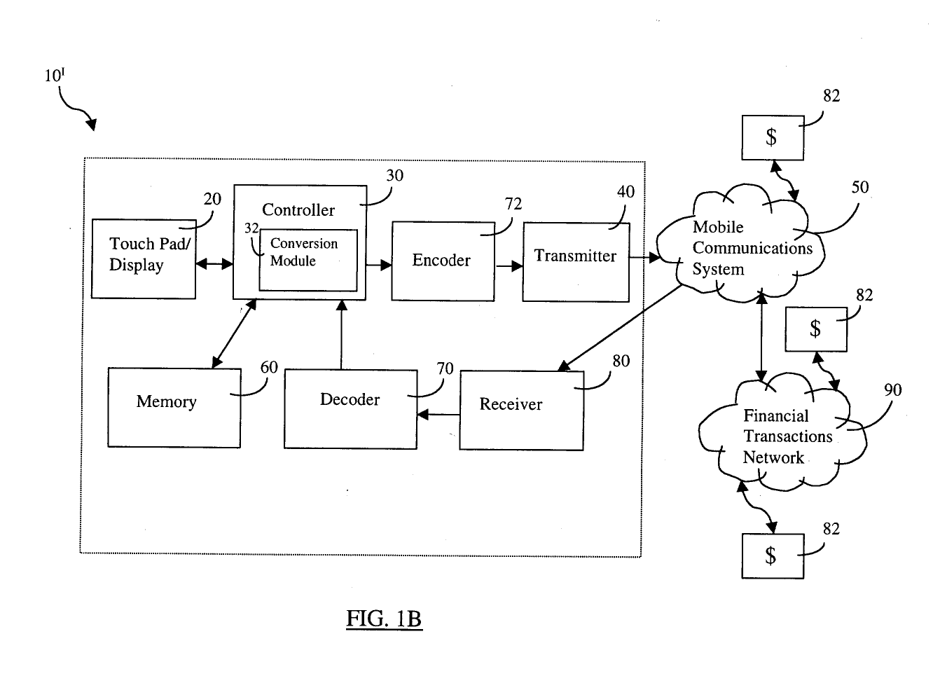

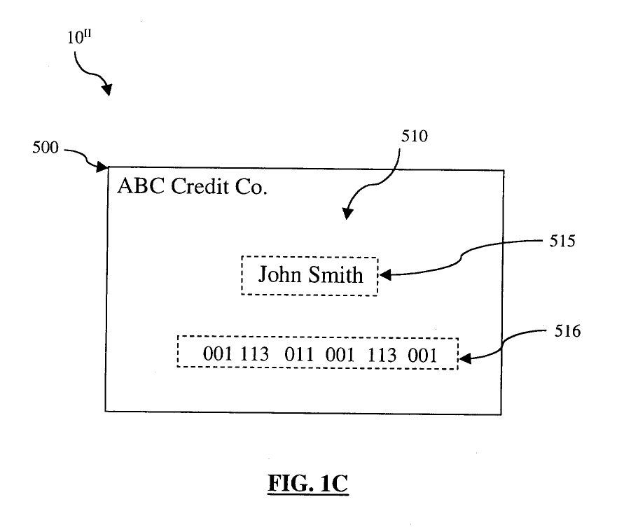

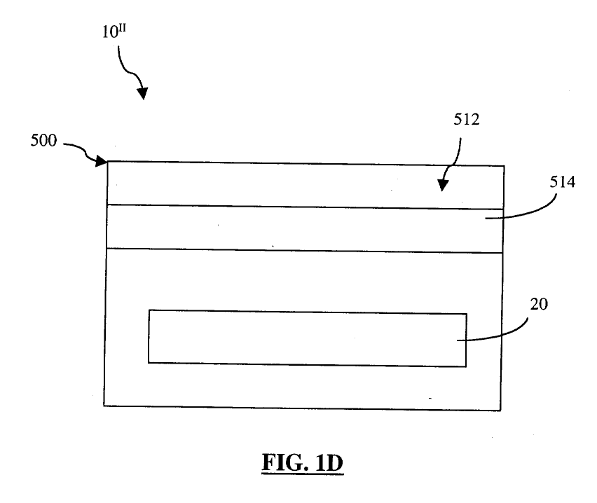

FIG. 1A is a schematic diagram illustrating components of a preferred embodiment of a messaging device shown generally as 10. Messaging device 10 can be constructed using a combination of existing mobile communications and graphical user interface technology, and software for character recognition and translation. Messaging device 10 will be equipped with a means (e.g. a power management system) for connecting to a power source (e.g. a battery management system) [not shown] to provide the power necessary for operation of the messaging device 10.

Messaging device 10 comprises a display 20 (e.g. a liquid crystal display (LCD) graphical user interface) that is used to display output to a user of messaging device 10. Preferably, display 20 is also a touch-sensitive pad (“touch pad”), which is used to receive input from the user of messaging device 10. However, in variant embodiments of the invention, a separate touch pad may be provided in addition to display 20 in the messaging device 10.

Controller 30 is used to control the output to be displayed in display 20, and to detect input from the user entered through display 20, where the display 20 is a touch pad. There are numerous ways in which controller 30 can prompt the user for input. For example, virtual keys (including a virtual keyboard) or buttons may be displayed in display 20. The buttons can be used to initiate certain specified functions or to input data when “touched” by a user. Lists of items may also be displayed in display 20, permitting the user to select an item by “touching” a specific item in the list, or by “touching” a checkbox, button, icon, or some other item selection indicator associated with an item in the list of items being displayed. The “touching” actions performed by a user may be performed using a stylus, a pen or pencil, or a finger, for example. By detecting what area of display 20 is being “touched” by the user, controller 30 can determine what input the user is providing.

Controller 30 may also provide a space in display 20 that permits the user to enter handwritten symbols as input to messaging device 10. The user can write a message in the space using a stylus, a pen or pencil, or a finger, for example. Controller 30 contains a conversion module 32 programmed to recognize handwritten symbols entered as input by a user, by associating the handwritten symbols with characters from a pre-defined character set.

Conversion module 32 converts the handwritten message into an outgoing message to be generated using characters from the pre-defined character set. Conversion module 32 may be programmed to recognize handwritten symbols written in a pre-defined input format and/or in an input format customized to a specific user of messaging device 10. The predefined character set may comprise alphanumeric characters, but may also comprise characters based on other languages including Chinese, Spanish, and/or Portuguese, for example. Conversion module 32 may also be programmed to convert sloppily written handwritten text to print text. As well, the controller 30 may also be programmed to translate the message from one language into another language selected by the user, prior to the message being sent.

Messaging device 10 also comprises a transmitter 40 for transmitting outgoing messages to remotely located users through a mobile communications system 50. Outgoing messages can be transmitted to remote users carrying devices such as pagers, cellular phones, personal digital assistants, systems connected to the Internet, or other messaging devices 10, for example, which are coupled to mobile communications system 50. In a preferred embodiment of the invention, outgoing messages may be transmitted from a messaging device 10 to other devices using the SMS protocol.

SMS allows users to send and receive short alphanumeric messages to and from mobile telephones and other similar devices. SMS can allow users to directly transmit messages to each other. SMS is also a “store and forward” method, and therefore, if the user for whom an outgoing message is intended is not available, the receiving device is powered off, or the unit is outside a service area, the outgoing message will appear when the device comes back online. SMS outgoing messages can also be sent “certified”, allowing the sender of an outgoing message to be notified when the user for which the outgoing message is intended receives the message.

Messaging device 10 also comprises short and long term data storage or memory 60 for storing data and software used by controller 30 or by other components of messaging device 10. Memory 60 may be used to store a list of telephone numbers, and optionally, names, addresses or other information associated with the telephone numbers. This list can be displayed to users in display 20 by controller 30. This allows users to select more quickly and easily a specified remote user to whom to send a message.

Memory 60 may also be used to store a list of outgoing messages. Outgoing messages that are used often (e.g. “favorites”) may be entered once by the user and saved in memory 60 for later retrieval. Optionally, some outgoing messages may also be pre-defined as default messages in the messaging device 10. The list of “favorite” outgoing messages can be displayed to users in display 20 by controller 30, allowing users to select a specific outgoing message to be sent to a remote user more quickly and easily, and without the need to re-enter the outgoing message every time the outgoing message is to be sent.

Messaging device 10 is also preferably equipped with components that allow it to receive incoming messages. Messaging device 10 can comprise a decoder 70 connected to controller 30. Decoder 70 is adapted to decode data received by the messaging device 10 through a receiver 80 connected to mobile communications system 50. Correspondingly, the messaging device may also enclose an encoder 72 configured to encode outgoing messages in accordance with SMS or other transmission protocols, prior to sending them via the transmitter 40. Receiver 80 may be coupled to an antenna (not shown). Messaging device 10 may also include other components common to GSM devices, as known in the art.

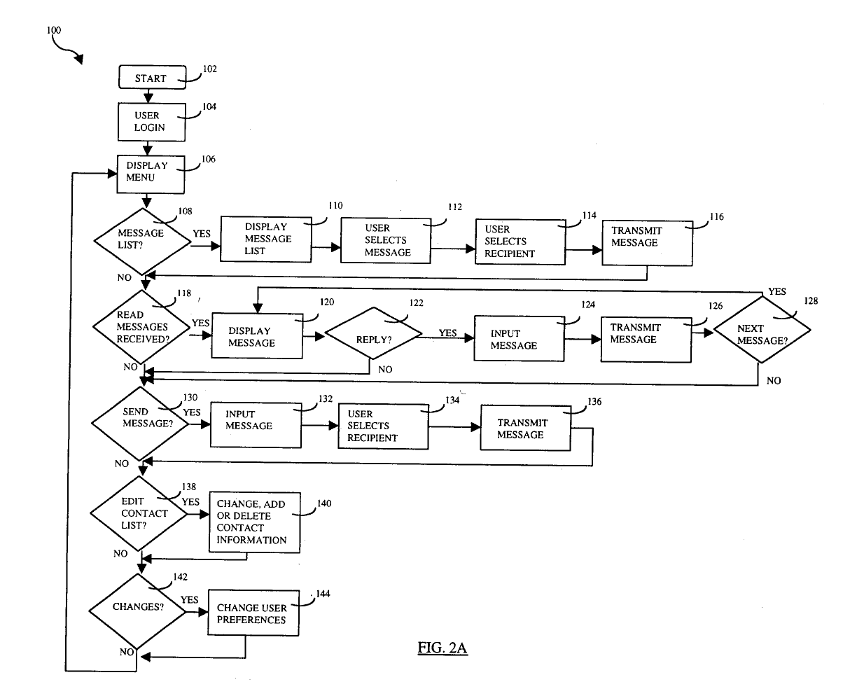

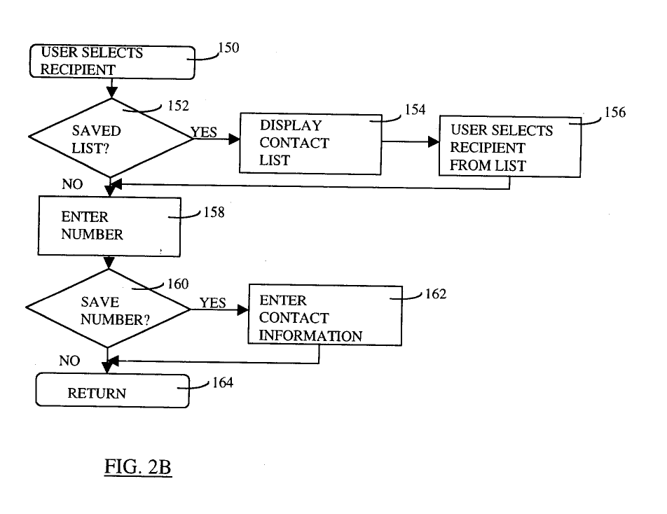

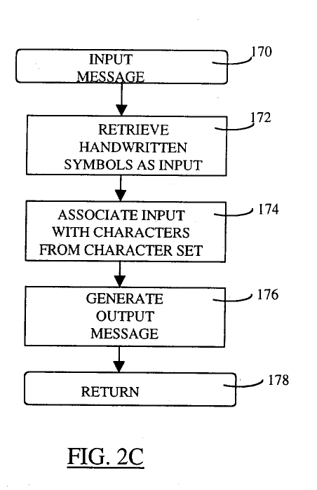

Referring to FIG. 2A, a flowchart is provided illustrating the steps of a method of generating and transmitting messages carried out by the messaging device 10 (FIG. 1) . The method is shown generally as 100, and commences at step 102.

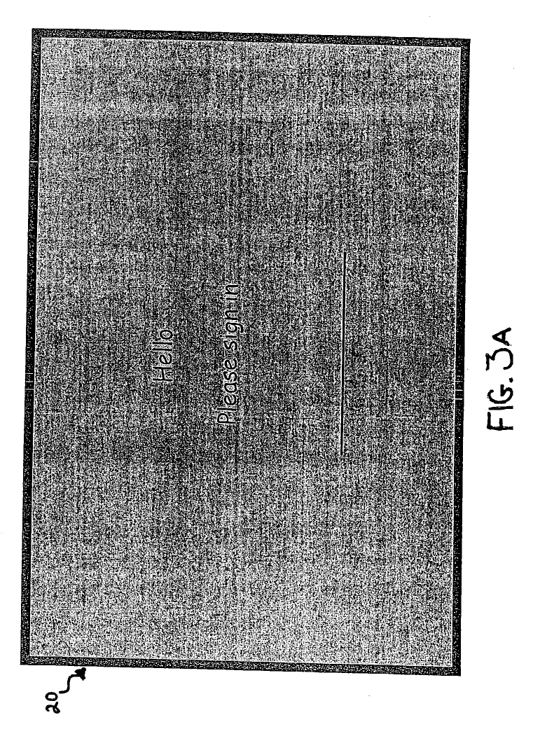

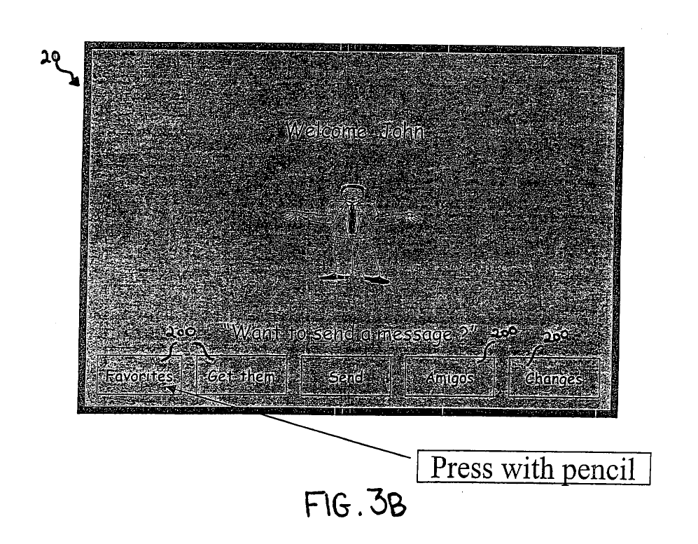

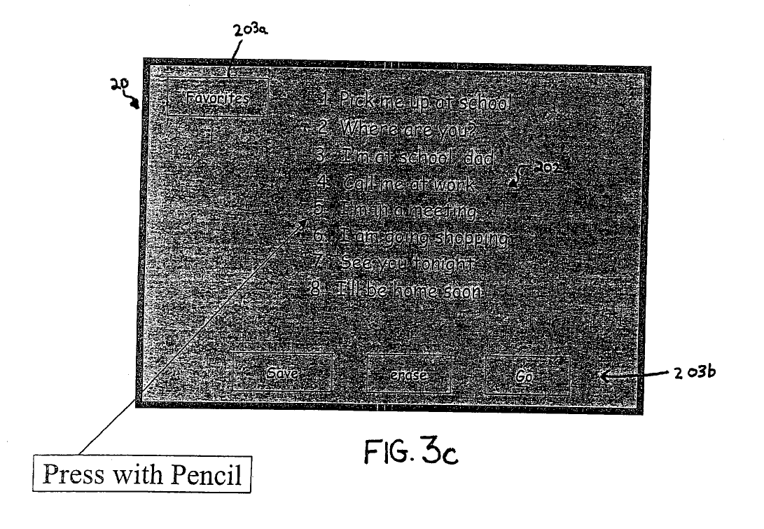

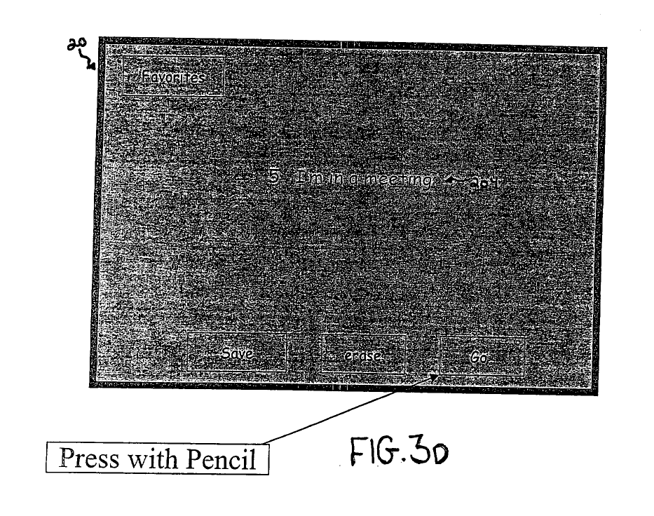

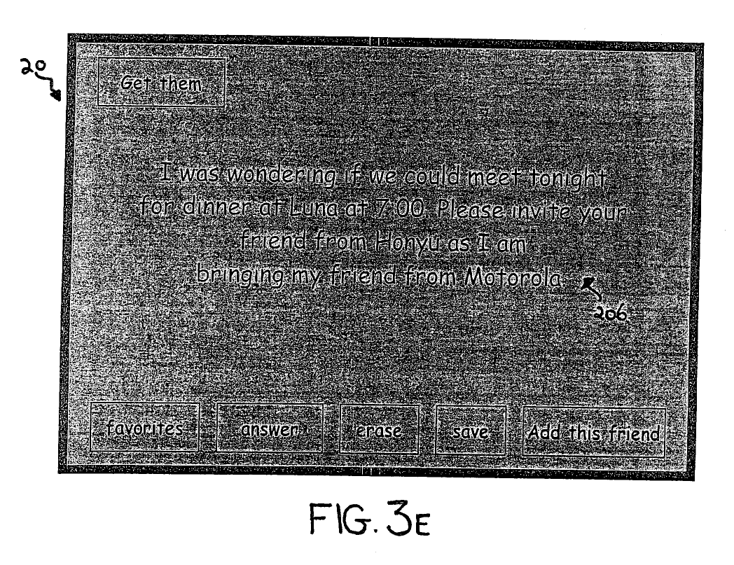

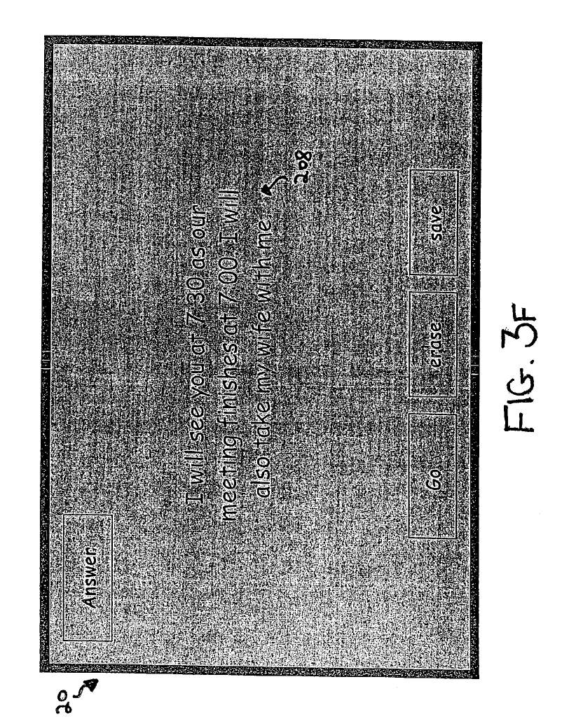

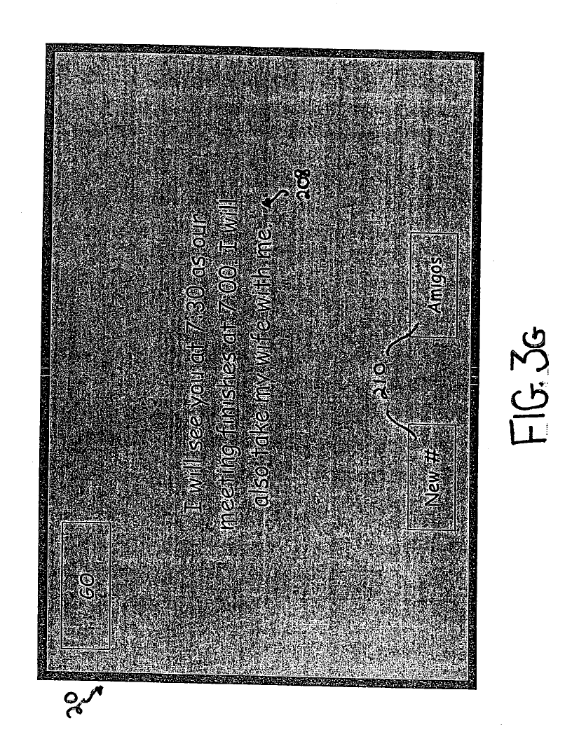

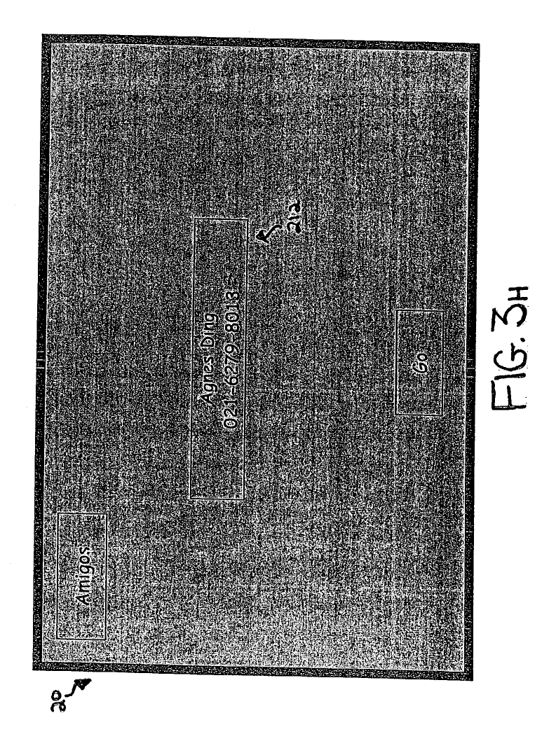

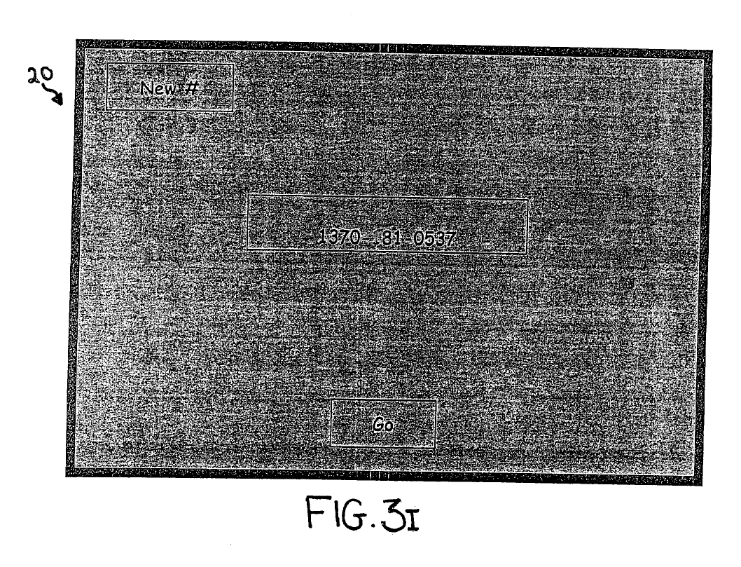

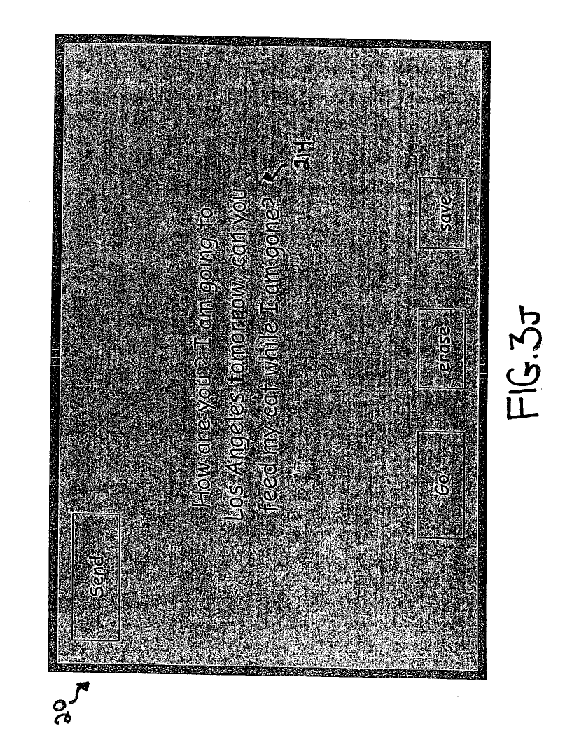

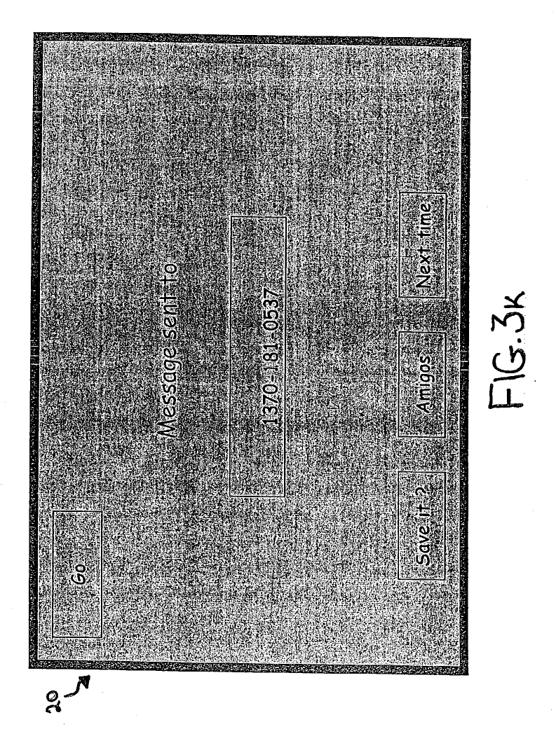

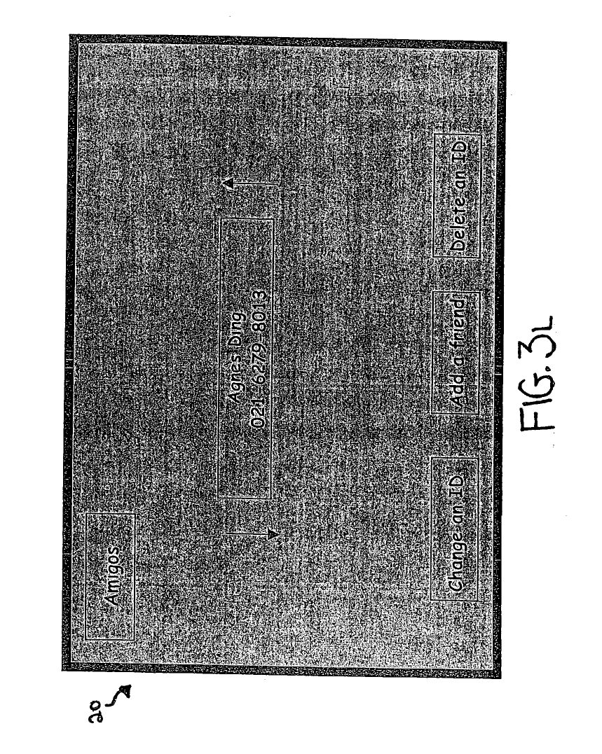

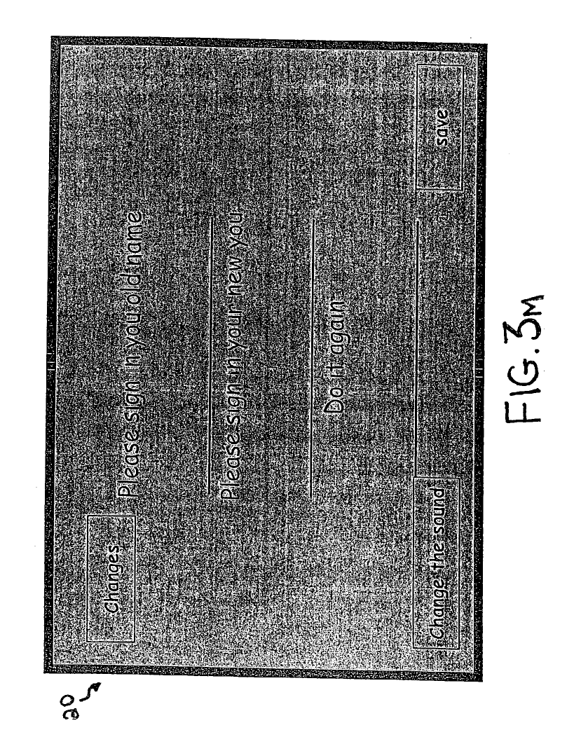

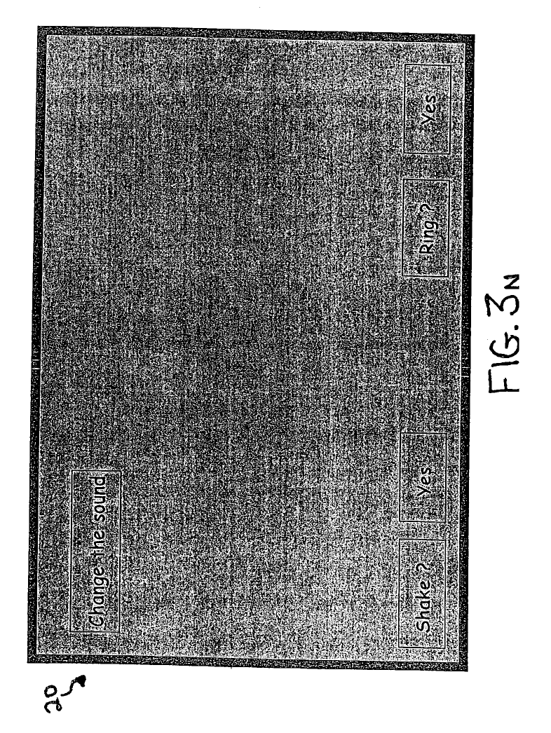

At step 104, the user can, by using biometrics software run by the controller 30, sign their name or other personal identifier to log in to the device 10. (See, for example, FIG. 3A and related discussion). The software will compare the input signature to an authorized signature previously stored in memory (e.g. memory 60) or other database or storage means in messaging device 10 and allow only the authorized user access to the device 10. Typically, the authorized signature data will be created and stored when the user initializes the device 10 upon its first use. For greater clarity, it should be understood that while the term “signature” generally means a person's handwritten name, it should also be understood herein to include other handwritten personal identifiers.

Optionally, a handwritten password and/or other handwritten identifiers may also be required as input by a user to gain access to the functionality of the messaging device 10. Key-entered passwords may be easily broken. On the other hand, a user's signature or handwritten password provides effective means for identifying the user more securely. Messaging device 10 may also be adapted to detect the points of pressure and speed used when a user enters his or her signature. This provides additional security when identifying or authenticating a user.

Although the handwritten signature of a user is used to identify the user in preferred embodiments of the invention as described herein, other biometric identification techniques may be used to identify the user in implementations of variant embodiments of the invention.

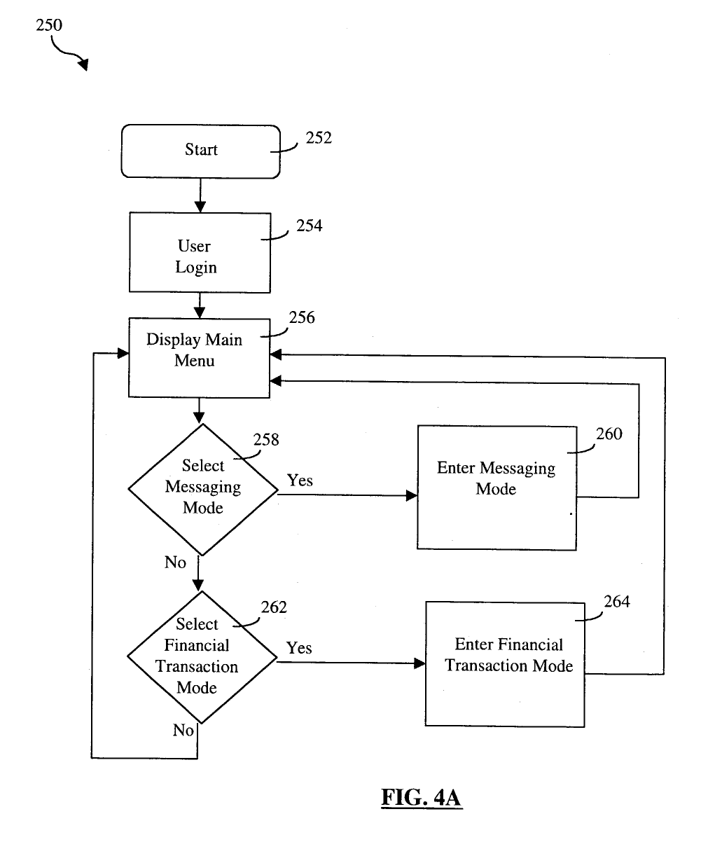

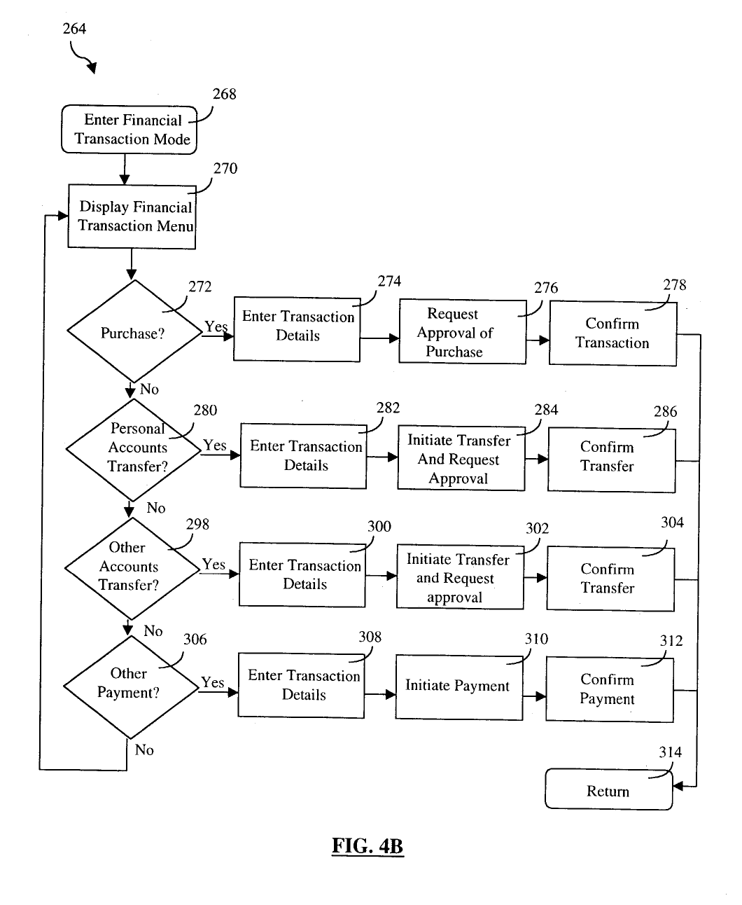

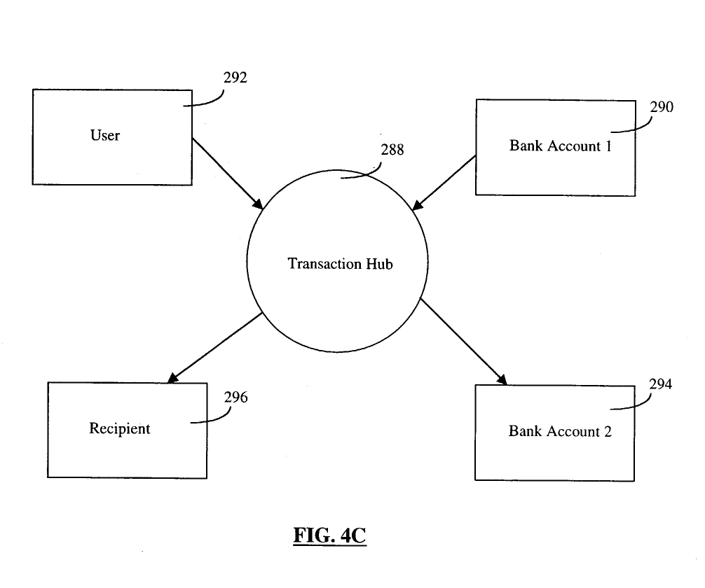

Biometric identification techniques generally use some unique physiological or behavioral characteristic of an individual to positively identify that individual. Biometric identification techniques can provide for increased security over more traditional identification techniques (e.g. use of alphanumeric key-based passwords). This may have significant advantages where the data stored in messaging device 10 is private, where messaging device 10, 10′ or 10″ may be equipped with the capability to initiate financial transactions (e.g. as explained in further detail below with reference to FIGS. 4A through 4C), or anytime where it is critical that the authenticity or identity of the user of messaging device 10 be verified. Other biometric identification techniques that may be used by messaging device 10 constructed in accordance with variant embodiments of the invention to identify a user may include fingerprint verification, hand geometry identification, voice verification, retinal scanning, iris scanning, facial recognition, other known techniques, or some combination thereof.

Furthermore, biometric identification techniques may be employed not only to identify a user when the user logs into messaging device 10, but also at other times a messaging device 10 is being used, particularly when performing tasks where extra security may be needed (e.g. in embodiments of the invention where messaging device 10 is equipped with financial transaction capabilities, as a step in processing a credit card purchase or withdrawal from an account).

Referring still to FIG. 2A, at step 106, a messaging menu is displayed to the user through the display 20 of messaging device 10. (See also FIG. 3B and the related discussion, below). The menu provides the user with various options to generate, send, and view received messages, for example. A form of greeting personalized to the specific user can also accompany the messaging menu.

At step 108, the controller 30 checks to see if the user has chosen to send a message from a user-defined list of outgoing messages stored in memory (e.g. memory 60 of FIG. 1), by selecting the corresponding option from the messaging menu displayed at step 106. If so, controller 30 displays the list of outgoing messages to the user at step 110, prompts the user to select an outgoing message and receives the selection as input at step 112, prompts the user to select a recipient for the outgoing message and receives the selection as input at step 114, and transmits the outgoing message to the selected recipient through the mobile communications system 50 at step 116.

At step 118, controller 30 checks to see if the user has chosen to read messages received by messaging device 10, by selecting the corresponding option from the messaging menu displayed at step 106. If so, controller 30 displays a received message at step 120 and prompts the user to check if he wishes to reply to that received message. If a reply is desired, controller 30 receives an outgoing message as input at step 124, and transmits the outgoing message to the user who sent the received message through a mobile communications system 50 at step 126. Controller 30 may also permit an outgoing message to be sent to additional and/or alternate users at step 126. The user may also choose to view additional received messages at step 128.

At step 130, controller 30 checks to see if the user has chosen to send a message to a remote user, by selecting the corresponding option from the messaging menu displayed at step 106. If so, controller 30 prompts the user to input an outgoing message using the touch pad 20 at step 132, prompts the user to enter or select a recipient's contact number for the outgoing message and receives the selection as input at step 134, and transmits the outgoing message through a mobile communications system 50 at step 136.

At step 138, controller 30 checks to see if the user has chosen to edit a contact list stored in the memory 60 comprised of pre-defined recipients or remote users and their corresponding contact numbers required for directing a message to them via the mobile communications system 50. If so, controller 30 proceeds to permit the user to change, add or delete contact information data on the contact list at step 140.

At step 142, controller 30 checks to see if the user has chosen to change user preferences associated with messaging device 10. For example, at step 144, using the touch pad 20 the user can choose to edit his handwritten login signature and/or handwritten password, or to change the alert mechanism for the messaging device 10 (e.g. vibrate on/off, ring on/off, varying ring types and volume).

The flow of method steps can then proceed back to step 106 at which the messaging menu is displayed in display 20. The steps of method 100 can continue repeatedly until messaging device 10 is powered off.

Referring to FIG. 2B, a flowchart illustrating the steps of a method of selecting a recipient for an outgoing message in a preferred embodiment of the present invention is provided. The steps of the method can be performed at step 114 or at step 134 of FIG. 2A, for example. The method of FIG. 2B commences at step 150.

At step 152, controller 30 checks to see if the user wishes to select a recipient or remote user to receive an outgoing message from a saved, user-defined list of recipients (i.e. a contact list). If so, controller 30 displays the contact list to the user at step 154, and permits the user to select a recipient for the outgoing message at step 156. Otherwise, at step 158, the user can enter a contact number (e.g. phone, fax, pager, messaging device number etc.) to which the outgoing message is to be sent. At step 160, the user also has the option to save the contact number entered in memory 60 at step 158, and to associate additional contact information (e.g. name, address) with the saved contact number at step 162.

At step 164, the method returns the contact number of the recipient selected at step 156 or the number entered at step 158 to controller 30, so that the outgoing message can be subsequently transmitted to that number.

Referring to FIG. 2C, a flowchart illustrating the steps of a method of inputting or generating an outgoing message to be sent to a recipient or remote user in a preferred embodiment of the present invention is provided. The steps of the method can be performed at step 124 or at step 132 of FIG. 2A, for example. The method of FIG. 2C commences at step 170.

At step 172, the user marks handwritten symbols on the display 20, which are received as input by controller 30.

The handwritten symbols are then converted or translated, preferably into an outgoing message text that can be sent over a mobile communications system using SMS, at steps 174 and 176. A conversion module (e.g. conversion module 32 of FIG. 1) identifies or recognizes the handwritten symbols by associating each symbol with at least one character from a set of pre-defined characters in a character set stored in the memory 60, at step 174. The user performs this continuously for each handwritten symbol input until an outgoing message is generated at step 176, typically by combining all characters associated with the handwritten symbols of the handwritten message. The outgoing message may also be generated by the user favorite or most-used phrases from a list stored in memory 60. The outgoing message generated at step 176 is then returned to the controller 30 for subsequent transmission to a remote user at step 178.

Symbols or character entered by the user may be converted by conversion module 32 on a character-by-character basis, and the outgoing message may be displayed to the user while it is being generated so the user may confirm its accuracy as the message is being entered into messaging device 10.

FIGS. 3A to 3N illustrate examples of output shown in a display (e.g. display 20 of FIG. 1) of a preferred embodiment of a messaging device 10 in use. These illustrations are provided as examples only. It will be understood by persons skilled in the art that variations of the displayed output can be incorporated in implementations of the present invention without departing from the scope of the invention.

FIG. 3A illustrates a login screen in display 20. The user can sign above the line indicated, to login and enable the messaging device.

FIG. 3B illustrates a messaging menu screen comprising a number of buttons 200 representing messaging menu options in display 20.

FIG. 3C illustrates a list 202 of outgoing messages that can be selected by a user in display 20, or altered by the user to create a unique user-defined list of favorite or most-used phrases. Although not shown in FIG. 3C, the user may be permitted to scroll through a list of outgoing messages. In the embodiment shown, the messaging menu item which has been selected and which is operative is displayed at the top left corner of display 20, as shown at 203a, while further messaging menu choices applicable to selected messaging menu item 203a are displayed in a line 203b at the bottom of display 20. This arrangement can be varied.

FIG. 3D illustrates a user-selected outgoing message 204 in display 20.

FIG. 3E illustrates a received message 206 shown in display 20 for viewing by a user.

FIG. 3F illustrates an outgoing message 208 entered by a user as a reply to received message 206 (FIG. 3E) in display 20.

FIG. 3G illustrates outgoing message 208 in display 20, and buttons 210 that prompt a user to select a recipient for the outgoing message 208.

FIG. 3H illustrates a selected recipient 212 for outgoing message 208 (FIG. 3G) in display 20.

FIG. 3I, alternatively, illustrates a screen in display 20 where the user has entered a number for the recipient to which outgoing message 208 (FIG. 3G) is to be sent.

FIG. 3J illustrates an outgoing message 214 that has been input by a user in display 20.

FIG. 3K illustrates a screen in display 20 where the user has entered a number for the recipient to which outgoing message 214 (FIG. 3J) is to be sent.

FIG. 3L illustrates a screen in display 20 in which recipients in a pre-defined contact list can be viewed, and subsequently added or deleted from the list. Contact information for existing recipients in the list can also be changed. The user can scroll through the recipients in the contact list.

FIG. 3M illustrates a screen in display 20 where a user can change his login information.

FIG. 3N illustrates a screen in display 20 where a user can change the alert mechanism used by messaging device 10.

Referring now to FIGS. 1B, 1C and 1D, illustrated therein are first and second variant embodiments of the messaging device of the present invention, shown generally as 10′ and 10″ which are adapted to facilitate financial transactions. Such transactions are typically initiated by the user.

The first variant of the messaging device 10′ comprises similar components to those of the preferred embodiment of the messaging device 10. However, as will be understood, the controller 30 will comprise additional financial transactions software to provide the financial transaction functionality as discussed in greater detail below. As will also be understood, while financial institutions 82 may be coupled directly to the mobile communications system 50, the mobile communications system 50 may connect to financial institutions 82 through a secure financial transactions network 90.

For example, messaging device 10′ can function as a credit card or debit card to be used by a user in the purchase of goods or services. As further examples, messaging device 10′ may be adapted to facilitate payments to and/or from the user (e.g. transferring cash from a user's account to a third party account or from a third party account to a user's account), communicate financial information (e.g. credit card information to a financial institution), and/or to initiate or otherwise facilitate other types of financial transactions (e.g. wire transfers, buying and selling securities, etc.). A “financial institution” as referenced in the specification or claims can be, for example, a bank, credit union, trust company, credit card company, credit agency, investment company or any other known institution or establishment that provides services to facilitate the financial transactions that may be supported by messaging device 10′. As will be understood, the device 10′ is preferably associated with at least one financial account controlled by the user, located at a financial institution.

Referring to FIG. 4A, a flowchart illustrating the steps of a method of generating and transmitting messages using messaging device 10′ in a variant embodiment of the present invention is provided. The method is shown generally as 250, and commences at step 252.

At step 254, the user can sign their name to login to messaging device 10′, in a similar manner as described above with respect to step 104 of FIG. 2A. The device 10′ verifies the identity of the user using the biometrics software and if a match allows the user to continue.

At step 256, a main menu is displayed on the display 20, which allows the user to select a specific mode of operation. In this embodiment, the user may choose between two primary menu options to specify a mode of operation: a messaging mode or a financial transaction mode. In other embodiments of the invention, a messaging device may be adapted to operate in different and/or additional modes of operation, which may be selected by a user at this step.

At step 258, a controller (e.g. 30 of FIG. 1) of messaging device 10′ checks to see if the user has selected the messaging mode by choosing the corresponding option from the main menu displayed at step 256. If so, the messaging mode is entered at step 260, in which a messaging menu is displayed on the display 20, allowing the user to select a messaging task. Tasks that may be performed in the messaging mode entered at step 260 are similar to those described above with reference to FIGS. 2A through 2C. While in the messaging mode, the user may exit the messaging mode to return to main menu, displayed at step 256.

At step 262, controller 30 checks to see if the user has selected the financial transaction mode by choosing the corresponding option from the main menu displayed at step 256. If so, the financial transaction mode is entered at step 264. Tasks that may be performed in the financial transaction mode entered at step 260 are described below with reference to FIG. 4B.

If an option has not been selected by the user, the flow of method steps may proceed back to step 256, such that the main menu is displayed until the user selects an option, or until the messaging device 10′ is powered off, for example.

FIG. 4B depicts a flowchart of the steps performed by messaging device 10′ in a financial transaction mode which commences at step 268.

At step 270, a financial transaction menu is displayed to the user on the display 20, which may provide the user with various financial transaction options. The options include the ability to make a purchase using the messaging device 10′ as a credit card or as a debit card, to initiate a transfer of funds between bank accounts or other accounts, or to initiate a payment, for example.

At step 272, controller 30 determines if the user has chosen to make a purchase from a merchant using messaging device 10′, by selecting the corresponding option from the financial transaction menu displayed at step 270. If so, controller 30 prompts the user for transaction details at step 274. The transaction details may include, for example, a merchant identifier, the amount, date and description of the purchase, and the user may be required to reenter his signature to authenticate the transaction.

Since the biometrics software has registered the user's authorized signature, the controller 30 may be programmed to perform an additional step (prior to communicating transaction details to the financial institution) of comparing the reentered signature to the authorized signature stored in memory 60. If the user's signature does not match the authorized signature, the controller 30 would terminate the transaction and no transaction data would be transmitted to the institution 82.

After the transaction details are entered, controller 30 generates an outgoing financial transaction message which includes data corresponding to the transaction details and a request for approval of the transaction. The financial transaction message is then transmitted to the financial institution 82 at step 276. The financial transaction message also includes data corresponding to a facsimile of the user's signature (or other biometric identification), in order to authenticate the user making the purchase.

Approval of the transaction will only occur after the financial institution 82 matches the facsimile signature to an authorized signature stored in the institution's 82 system databank. As will also be understood, the institution 82 will also perform similar checks as those performed for standard debit card or credit card transactions (eg. to confirm a sufficient balance of funds exists in the user's account for a debit transaction), prior to approving a transaction.

The financial institution 82 confirms the transaction by displaying an approval or authorization code to the messaging device 10′ which the merchant can record if so desired. However it is recommended that the institution 82 also send confirmation of the transaction to both the user and the merchant via the internet such as through email. The merchant and the user, using their respective accounts, can also check the institution's 82 website for a transaction record which the institution 82 would preferably store in a transaction file at step 278. If the transaction is not approved, an appropriate rejection code may be transmitted by the institution 82 to the device 10′ and displayed to the user at step 278.

In preferred embodiments of the invention, controller 30 of messaging device 10′ communicates directly with a financial institution 82 in requesting initiation and approval of financial transactions, and in receiving confirmation of these transactions (e.g. as performed at steps 276 and 278). The user would input or select the institution's 82 access or contact number and direct the controller 30 to establish a connection with the financial institution 82. As will be understood, for example, if the selected financial institution is a credit card company such as American Express™, the access or contact number would be the assigned number to which messages to American Express could be transmitted. Once connectivity is secured, the institution 82 preferably transmits a welcome greeting message to the device 10′, which is displayed to the user. Upon receiving this confirmation of connectivity, the user continues using the device 10′ to initiate the desired transaction along the lines discussed above.

The device 10′ can also be used to purchase products advertised on the internet or television. Such a transaction may involve the user inputting or selecting the financial institution's contact number, inputting or selecting the user's financial account to be debited, inputting the merchant number, the product number and the cost of the product to be purchased, and then the user would preferably be required to sign the device's 10 touch pad 20 to authorize the transaction in the manner described above.

Approval of a transaction by the financial institution 82 may be transmitted to the device 10′ as a code with confirmation transaction data sent to the merchant and the user via the Internet such as by email. Alternatively or in addition, the transaction information could be stored by the institution 82 in the user's and merchant's online monthly transaction folders for review and/or printing in a monthly statement.

The device 10′ may also be configured to enable the withdrawal of cash from an automated teller machine (ATM). For such a transaction, the user would visit the desired ATM machine, input into the device 10 using the touch pad 20 the transaction details including the institution's 82 contact number, the ATM identification number assigned by the owner of the ATM machine, and the amount to be withdrawn into the device 10 using the touch pad 20. Again, preferably, the user would be required to sign the touch pad 20 to authorize the transaction in the manner described previously. The transaction details would then be transmitted to the institution 82 by the device 10′. Upon approving the transaction, the institution 82 then sends approval to the ATM machine, which would then dispense the money.

Since the transaction details (e.g., merchant identifier and amount of purchase in a debit or credit card transaction) and the user's signature (or other biometric identification) which are used to authorize the transaction can be entered into messaging device 10′, the need for a merchant reader can be eliminated in a preferred embodiment of this invention.

Credit card account and/or debit card account numbers, for example, associated with the user can be stored in the memory 60 of the messaging device 10′, and can be selected by the user and automatically included in the outgoing message generated by the controller 30 and communicated to the financial institution 82 when performing the financial transaction.

As noted previously, the financial institution 82 may configure its system to provide confirmation of financial transactions directly to the user's messaging device 10′, and optionally to other messaging devices 10′ of other users. Confirmation of financial transactions may also be directed elsewhere by the user or financial institution, by sending an e-mail to an address designated by a merchant for receiving an electronic record of each initiated financial transaction associated with that merchant, or similarly by sending an e-mail to an address designated by the user for receiving an electronic record of financial transactions, in accordance with any user's preferences which may be optionally specified (e.g. send e-mail record of approved transactions only), for example. These capabilities further facilitate the performance of paperless transactions.

At step 280, controller 30 checks to see if the user has chosen to transfer funds between personal accounts, by selecting the corresponding option from the financial transaction menu displayed at step 270. If so, controller 30 prompts the user for transaction details at step 282. After the transaction details are entered, preferably for added security the user is required to sign the device 10′, approving the transaction.

Controller 30 requests initiation of the transfer and approval of the transfer from a financial institution at step 284. At this step, controller 30 can also communicate to the financial institution 82 a facsimile of the user's signature (or other biometric identification), in order to authenticate the user initiating the transfer. The financial institution confirms the transaction at step 286.

Referring to FIG. 4C, the transfer may be facilitated by an external transaction hub 288 that is adapted to retrieve funds from a first bank account 290 belonging to a user 292 who initiates the transfer using his messaging device 10, and to deposit the retrieved funds to a second bank account 294 belonging to a recipient 296. For example, in a transfer of funds between personal accounts, user 292 may be a parent transferring funds to his child (i.e. recipient 296).

Similarly, as indicated earlier with respect to purchases from a merchant, account numbers associated with the user can be stored in the memory 60 of the user's messaging device 10′, and can be selected by the user and automatically included in the outgoing message generated by the controller 30 and communicated to the financial institution 82 when performing the funds transfer.

The financial institution's 82 system is preferably configured to provide confirmation of this financial transaction directly to the user's messaging device 10′, and optionally to other messaging devices 10′ of other users. Confirmation of financial transactions may also be directed elsewhere by the user or financial institution, by e-mail to addresses designated by the recipient of the transfer and designated by the user, for example.

Referring again to FIG. 4B, at step 298, controller 30 checks to see if the user has chosen to transfer funds between “other” accounts, by selecting the corresponding option from the financial transaction menu displayed at step 270. If so, controller 30 prompts the user for transaction details at step 300. After the transaction details are entered, the user may be prompted to sign the device 10′ for authentication and approval. The controller 30 then requests initiation of the transfer and approval of the transfer from a financial institution at step 302. At this step, controller 30 also communicates to the financial transaction a facsimile of the user's signature (or other biometric identification) in order to authenticate the user initiating the transfer. The financial institution confirms the transaction at step 304.

Referring again to FIG. 4C, the transfer may be facilitated by an external transaction hub 288 that is adapted to retrieve funds from a first bank account 290 belonging to a user 292 who initiates the transfer using his messaging device 10′, and to deposit the retrieved funds to a second bank account 294 belonging to a recipient 296. For example, in a transfer of funds between “other” accounts, user 292 may be an employer transferring funds to an employee (i.e. recipient 296), as reimbursement for expenses for example, or for other purposes. As will be understood, separate options for personal and business account transfers have been discussed herein; however, it will be appreciated by those skilled in the art that any of a number of different options and categorizations may be implemented in variant embodiments of the invention.

Similarly, as indicated earlier with respect to purchases from a merchant, account numbers, for example, associated with the user can be stored in the memory 60 of the user's messaging device 10′, and can be selected by the user and automatically included in the outgoing message generated by the controller 30 and communicated to the financial institution 82 when performing the funds transfer.

Confirmation of this financial transaction may be provided directly to the user's messaging device 10′, and optionally to other messaging devices 10′ of other users. Confirmation may also be directed elsewhere by the user or financial institution, by sending an e-mail to addresses designated by the user and/or the recipient of the transfer.

Referring again to FIG. 4B, at step 306, controller 30′ checks to see if the user has chosen to make a payment to another messaging device 10′, by selecting the corresponding option from the financial transaction menu displayed at step 270. If so, controller 30 prompts the user for transaction details at step 308. After the transaction details are entered, the user signs the device prompting approval. The controller 30 then initiates payment at step 310. At this step, controller 30 may also communicate a facsimile of the user's signature (or other biometric identification) to the financial institution, in order to authenticate the user. Subsequently, the payment is confirmed at step 312.

In this manner, messaging devices 10′ can be used as smart cards, in which funds may be transferred between messaging devices 10′. Each messaging device 10′ may be connected to a funds account where funds may be deposited or withdrawn.

In variant embodiments of the invention, payments may also be made directly to other electronic devices, such as vending machines or parking meters, for example. Confirmation of the transactions would preferably be placed in the user's monthly statement for review.

Similarly, as indicated earlier with respect to purchases from a merchant, confirmation of this financial transaction may be provided directly to the user's messaging device 10′ and also to other messaging devices 10′ of other users. One or more financial accounts (for which associated financial account numbers may be stored in the device's 10′ memory 60), would be debited with each transaction. Confirmation of financial transactions may also be directed elsewhere by the user or financial institution, by e-mail to addresses designated by the user and/or recipient of the payment.

If the user has not selected an option, the financial transaction menu may be displayed at step 270 until an option is selected, or until messaging device 10′ is powered off. After an option is selected by a user and the corresponding steps are performed, the financial transaction mode may be exited at step 314, and the user is returned to the main menu. If the display is left open, there is no risk since a signature (biometric) is necessary for every transaction approval.

It will be appreciated by those skilled in the art that in variant embodiments of the invention, messaging device 10′ may be adapted to provide the user with different financial transaction options than those described above, which are provided for illustrative purposes only.

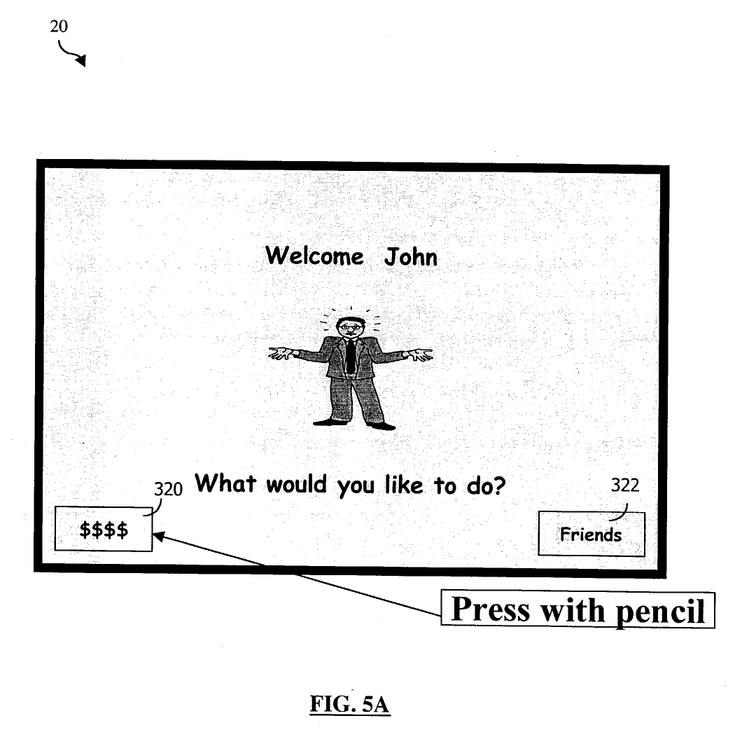

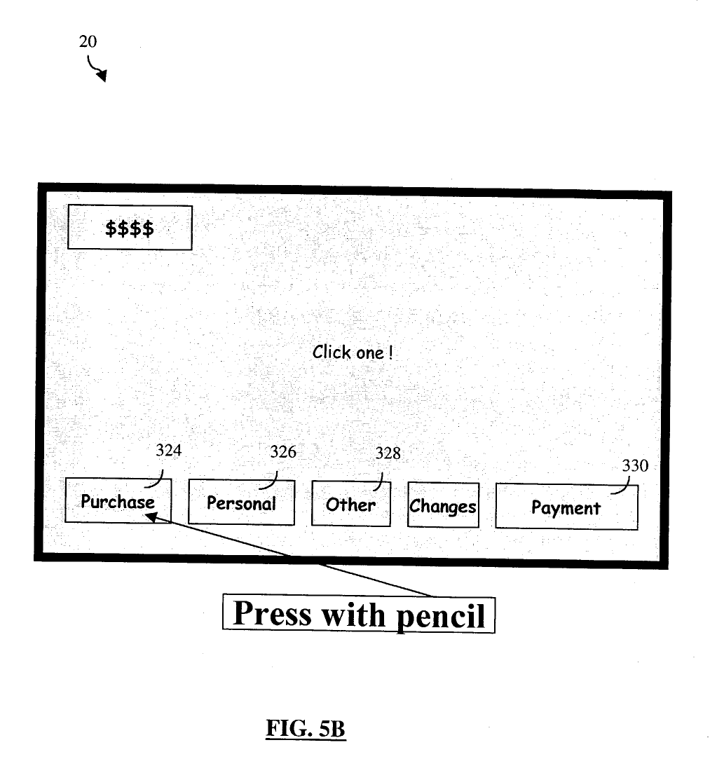

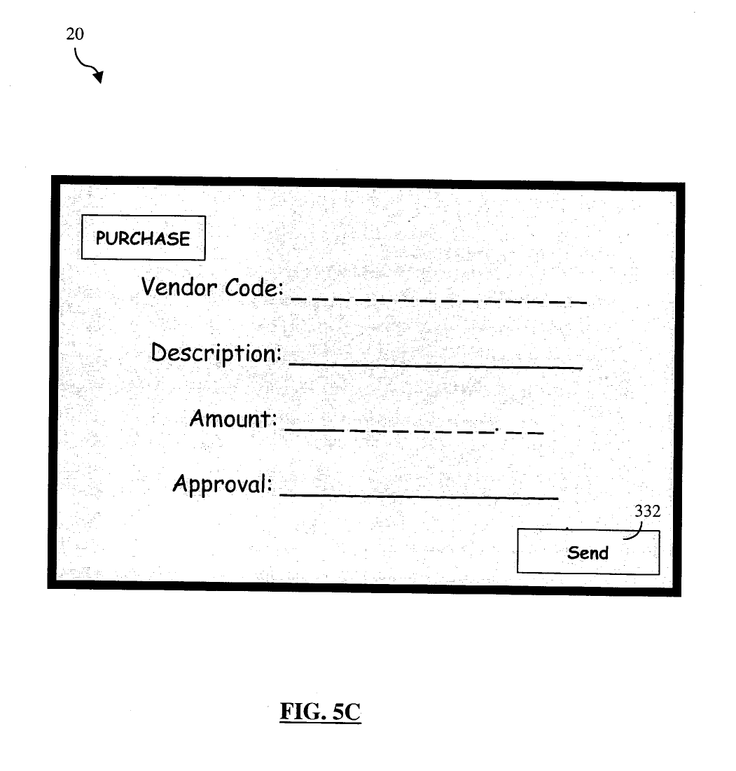

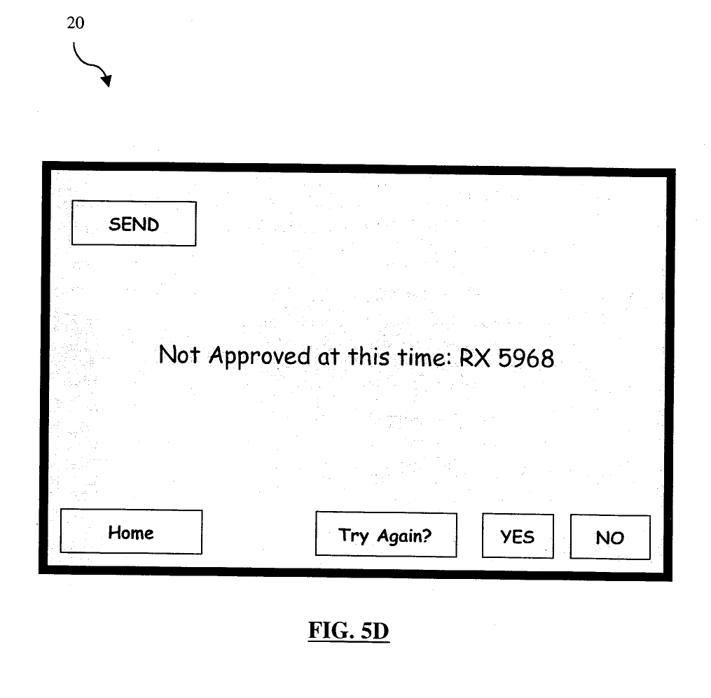

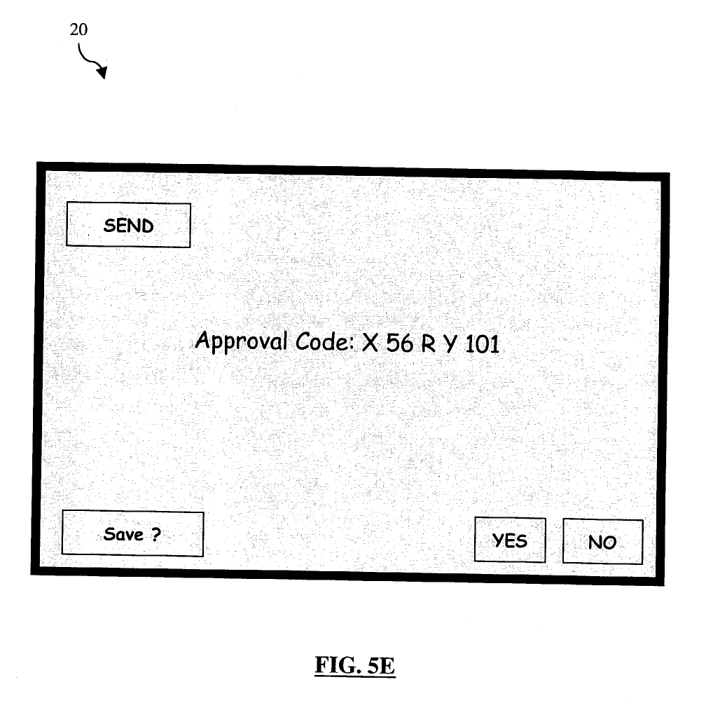

FIGS. 5A to 5E illustrate examples of output shown in a display 20 of the first variant embodiment of a messaging device 10′ in use. These illustrations are provided as examples only. Variations of the displayed output can be incorporated in implementations of the present invention without departing from the intended scope of the invention.

FIG. 5A illustrates a main menu in display 20 of messaging device 10′ which is equipped with messaging capabilities and which can also be used to perform financial transactions. The user can select a first main menu option 320 to perform financial transactions or a second main menu option 322 to display a messaging menu (e.g. see screen of FIG. 3B) so that messaging tasks can be performed.

FIG. 5B illustrates a financial transaction menu screen displayed in display 20 after first main menu option 320 of FIG. 5A was selected. In this example, the financial transaction menu screen comprises a number of buttons representing financial transaction menu options, including a “purchase” button 324 to initiate a credit card purchase, a “personal” button 326 to initiate a transfer of funds between personal accounts, an “other” button 328 to initiate a transfer of funds between other accounts, and a “payment” button 330 to initiate a payment to another messaging device 10′.

FIG. 5C illustrates a transaction detail entry screen displayed in display 20, in which a user or merchant can enter details of a purchase, after “purchase” button 324 of FIG. 5B is selected. Approval of the purchase can be requested by selecting a button 332.

FIG. 5D illustrates an example of a confirmation screen displayed in display 20 indicating that the transaction was rejected by the financial institution 82. Alternatively, a confirmation screen such as that shown in FIG. 5E may be displayed, which indicates that the transaction was approved.

Referring back to FIGS. 1C and 1D, the second variant of the messaging device 10″ is also adapted for use in financial transactions, and includes components generally similar to those of the messaging device 10′. The messaging device 10″ is also provided with a housing 500 which is sized and shaped similar to that of a standard credit card. Preferably the dimensions of the housing will be in the range of 55 mm to 60 mm in height by 85 mm to 95 mm in width by 5 mm to 10 mm in thickness or depth, although other dimensions would be possible. This allows the messaging device 10″ to be stored more compactly (e.g. in a wallet), and be more recognizable to merchants as a credit card or debit card.

The front face 510 of the device 10″ is similar to standard credit cards, and possesses embossed alphanumeric characters identifying the card holder or account name 515 and card account number 516. The back face 512 of the card device 10″ comprises a touch pad 20 (which is preferably also a display screen) and a magnetic stripe 514. The magnetic stripe 514 magnetically stores the account number 516 and other data similar to that of standard credit cards or debit cards.

The account number 516 is also stored in the memory 60 of the card device 10″. Data corresponding to the user's authorized signature is also preferably stored in the memory 60. For security purposes, preferably the authorized signature data stored in the memory 60 cannot be changed once the card device 10″ has been initialized. Typically, only one financial account (and one corresponding account number 516) managed by one financial institution 82 will be associated with the card device 10″. As well, these financial accounts are typically credit or debit accounts.

The card device 10″ may be somewhat thicker than standard credit cards, in order to accommodate a wafer thin rechargeable battery, controller 30, touch screen 20 and other components of the device 10″ sandwiched in between the front 510 and rear 512 faces. However, the card device 10″ is preferably sufficiently thin to be able to be swiped through standard credit card and debit card readers.

When using the card device 10″, a credit or debit transaction is initiated in a manner similar to standard credit card or debit card transactions. The merchant enters the price information (and other transaction details, such as product identifiers, etc.) into the merchant's cash terminal. The cash terminal is operatively coupled to a credit card/debit card reader, and awaits approval of the transaction from the card reader once the merchant designates a credit card/debit card transaction. As will be understood, the merchant's card reader is operatively coupled to a secure financial transactions network 90.

The card device 10″ is swiped through the card reader, which retrieves account number 516 and other data associated with the card device 10″ and stored on the magnetic stripe 514. The merchant's reader then contacts the associated financial institution's 82 system via the secure financial transactions network 90 and requests approval of the transaction.

The account managed by the financial institution 82 is designated in the institution's system as being associated with a card device 10″. As will be understood, the financial institution's 82 system is configured. The financial institution's 82 system performs standard checks (e.g. credit availability) used in approving typical credit card or debit card transactions. The institution's 82 system also awaits authorization data from the card device 10″, prior to approving the transaction. If the authorization data is not received within a short designated period of time, the institution's 82 system transmits a rejection of the transaction to the merchant's reader.

The user is prompted to sign the signature touch pad 20. Using the programmed biometrics software, the controller 30 compares the user's signature to the user's authorized signature stored in memory 60. If the user's signature matches the authorized signature, the controller 30 generates an authorization message containing authorization data, which is transmitted to the financial institution's 82 system. The authorization data includes an approval code or may include data corresponding to the user's signature, which the institution's 82 system may be configured to biometrically compare to authorized signature data stored by the system.

If the controller 30 determines that the user's signature does not match the authorized signature data, the controller 30 may prompt the user may to re-sign the touch pad 20 for authorization. Similarly, if the financial institution's 82 system determines that the user's signature is unauthorized, the system generates and sends an unauthorized signature message to the card device 10″, and the controller 30 may prompt the user to re-sign the touch pad 20.

If after a reasonable number of attempts (eg. 3) in which the user's signature is not matched to authorized signature data, an appropriate message is generated and transmitted from the card device 10″ to the financial institution's 82 system rejecting the transaction. The financial institution's 82 system then generates and transmits the rejection of the transaction to the merchant's card reader. Additionally, the controller 30 may be programmed to deactivate the card device 10″, and if a the touch pad 20 is also a display, the controller 30 may cause an appropriate message such as “UNAUTHORIZED USER” to be permanently displayed on the display 20.

As yet another alternative, instead of the card device 10″ storing authorized signature data and comparing it to the user's signature data for authorization, the card device 10″ may input the user's signature data and the controller 30 may then generate an authorization message containing authorization data, which is transmitted to the financial institution's 82 system. The card device 10″ would neither store nor compare an authorized signature, and would not require biometrics software. In such an alternative configuration, the authorization data would include data corresponding to the user's signature, which the institution's 82 system would be configured to biometrically compare to authorized signature data stored by the system. The financial institution's 82 system would be configured to transmit appropriate messages to the card device 10″ in the event the user's signature did not conform to the authorized signature data.

In the event the user's signature data matches the authorized signature data and the transaction satisfies the standard credit/debit checks, the financial institution's system approves and processes the transaction and generates and transmits an appropriate approval message to both the card device 10″ and to the merchant's reader.

The present invention has been described with regard to specific embodiments. However, it will be obvious to persons skilled in the art that a number of other variants and modifications can be made without departing from the scope and spirit of the invention defined in the claims appended hereto.

1. A messaging device comprising:
a) a touch pad for receiving input from a first user, wherein said input comprises a plurality of handwritten symbols written on said touch pad;
b) a controller operatively coupled to the touch pad;
c) a conversion module programmed to associate each of said plurality of handwritten symbols to at least one of a plurality of pre-defined characters;
d) wherein the controller is adapted to generate outgoing message data comprised of pre-defined characters associated with said plurality of handwritten symbols and wherein said outgoing message data also comprises contact data corresponding to an intended recipient of the message data;
e) memory storage operatively coupled to the controller;
f) a transmitter adapted to transmit said outgoing message to a mobile communications system;
g) wherein the transmitter is not adapted to transmit voice communications; and
h) a receiver for receiving data through said mobile communications system.

2. The messaging device of claim 1, wherein said outgoing message is transmitted in accordance with a Short Message Service protocol.

3. The messaging device of claim 1, wherein said plurality of pre-defined characters include alphanumeric characters.

4. The messaging device of claim 1, wherein said plurality of pre-defined characters include Chinese characters.

5. The messaging device of claim 1, wherein said input further comprises a selection of one of a plurality of user-defined identifiers stored in said memory, wherein each of said plurality of user-defined identifiers corresponds to an intended recipient of the message.

6. The messaging device of claim 1, wherein said input further comprises a selection identifying one of a plurality of user-defined messages stored in said memory.

7. The messaging device of claim 1, further configured to identify an authorized user using a biometric identification technique.

8. The messaging device of claim 7, wherein said biometric identification technique is a handwriting recognition technique.

9. The messaging device of claim 1, wherein the controller is programmed to generate an outgoing message corresponding to a financial transaction.

10. The messaging device of claim 9, wherein the financial transaction includes at least one of the group consisting of: a credit purchase or a debit purchase.

11. The messaging device of claim 1, further comprising a display operatively coupled to the controller.

12. The messaging device of claim 1, wherein the touch pad is also a display.

13. A messaging device comprising:
a) means for receiving input from a first user, wherein said input comprises a plurality of handwritten symbols;
b) means for converting said plurality of handwritten symbols to a plurality of pre-defined characters;
c) means for generating an outgoing message comprised of said plurality of pre-defined characters and wherein said outgoing message comprises contact data corresponding to an intended recipient of the message;
d) means for transmitting said outgoing message to a mobile communications system; and
e) means for receiving messages from said mobile communications system.

14. The messaging device of claim 13, wherein said outgoing message is transmitted to said second user in accordance with a Short Message Service protocol.

15. The messaging device of claim 13, wherein said plurality of pre-defined characters include at least one selected from the group consisting of: alphanumeric characters and Chinese characters.

16. The messaging device of claim 13, wherein said messaging device includes means for identifying said first user using a biometric identification technique.

17. The messaging device of claim 16, wherein said biometric identification technique is a handwriting recognition technique.

18. The messaging device of claim 13, wherein said messaging device further comprises means for facilitating one or more financial transactions.

19. The messaging device of claim 18, wherein said one or more financial transactions includes at least one selected from the group consisting of: a credit purchase and a debit purchase.

20. A method of generating and transmitting a message to a remote user using a portable messaging device, wherein said portable messaging device is not adapted to transmit voice communications, said method comprising the steps of:
a) receiving as input from a first user a plurality of handwritten symbols;
b) associating each of said plurality of handwritten symbols to at least one of a plurality of pre-defined characters;
c) generating an outgoing message comprised of pre-defined characters associated with said plurality of handwritten symbols and wherein said outgoing message comprises contact data associated with the remote user; and
d) transmitting said outgoing message to a mobile communications system.

21. The method of claim 20, wherein said outgoing message is transmitted to said mobile communications system in accordance with a Short Message Service protocol in step (d).

22. The method of claim 20, wherein said plurality of pre-defined characters includes at least one selected from the group consisting of: alphanumeric characters and Chinese characters.

23. The method of claim 20, further comprising the step of identifying an authorized user using a biometric identification technique.

24. The method of claim 20, wherein said biometric identification technique is a handwriting recognition technique.

25. A method of performing a financial transaction using a portable messaging device, said method comprising the steps of:
a) identifying a type of financial transaction to be initiated;
b) receiving transaction details;
c) obtaining biometric identification from said user and authenticating said user;
d) requesting approval of said financial transaction from a financial institution; and
e) obtaining confirmation of said financial transaction.

26. The method of claim 25, wherein said financial transaction is selected from the group consisting of: credit purchase, debit purchase, funds transfer between accounts, funds transfer between messaging devices, payment, and communication of financial information.

27. The method of claim 25, wherein said biometric identification is said user's handwritten signature.

28. A card device comprising:
a) a housing configured to operatively engage a card reader;
b) a magnetic stripe mounted to the housing, wherein said magnetic strip stores account data;
c) a touch pad for receiving input from a user, wherein said input comprises a signature;
d) a controller operatively coupled to the touch pad;
e) wherein said controller is adapted to generate outgoing message data comprising authorization data, and wherein said outgoing message data further comprises account data; and
f) a transmitter adapted to transmit said outgoing message data to a mobile communications system.

29. The card device of claim 28, further comprising a receiver for receiving data from said mobile communications system.

30. The card device of claim 29, wherein the housing is of substantially similar size and shape as that of a standard credit card.

31. The card device of claim 29, further comprising:
a) a memory adapted to stored data corresponding to an authorized signature;
b) and wherein the controller is programmed to compare said input signature to said authorized signature.

32. A method of performing a financial transaction using a card reader, said method comprising the steps of:
a) providing a portable card device adapted to operatively communicate with said card reader;
b) providing transaction details to the card reader;
c) transmitting transaction details data from said card reader to a financial institution associated with said account data;
d) requiring the user to sign the card device;
e) transmitting authorization data from the card device to said financial institution;
f) requesting approval of said financial transaction from said financial institution;
g) processing said financial transaction; and
h) obtaining confirmation of said financial transaction.

33. A method of performing financial transactions as claimed in claim 32, wherein said portable card device comprises:
a) a housing configured to operatively engage the card reader;
b) a magnetic stripe mounted to the housing, wherein said magnetic strip stores account data associated with a financial institution;
c) a touch pad for receiving input from a user, wherein said input comprises a signature;
d) a controller operatively coupled to the touch pad;
e) wherein said controller is adapted to generate outgoing message data comprising authorization data, and wherein said outgoing message data further comprises account data; and
f) a transmitter adapted to transmit said outgoing message data to a mobile communications system.
